(19) United States
(12) Patent Application Publication
(10) Pub. No.: US 2005/0112413 A1
(43) Pub. Date: May 26, 2005

(54) Gas barrier film

(75) Inventors: Hideki Masuda, Hiratsuka-shi (JP); Jun Akui, Hiratsuka-shi (JP); Osamu Isozaki, Yokohama-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: KANSAI PAINT CO., LTD., Amagasaki-shi (JP)

(21) Appl. No.: 11/023,532

(22) Filed: Dec. 29, 2004

(30) Foreign Application Priority Data
Jul. 3, 2000 (JP) 2000-200682
Jul. 12, 2000 (JP) 2000-211846
May 22, 2001 (JP) 2001-152445

(51) Int. Cl. G03C 5/16; B05D 3/02

(52) U.S. Cl. 428/702; 427/372.2; 427/376.2; 428/336; 428/500

(57) ABSTRACT

The present invention provides a gas barrier film comprising at least one titanium oxide film layer (B) laminated on one or both sides of a plastic film layer (A). The film of the invention has excellent barrier properties to gases such as oxygen, carbonic acid gas and water vapor, good UV screening properties, good flavor retention properties, and high transparency.

### TECHNICAL FIELD

The present invention relates to novel gas barrier films.

### BACKGROUND ART

Food packaging films need to have barrier properties to gases (e.g., oxygen, carbonic acid gas and water vapor), UV screening properties and flavor retention properties, to prevent deterioration in flavor and freshness. They also require high transparency that permits the contents of the packages to be seen through, when considering display in stores.

Conventionally used gas barrier packaging films comprise, as a gas barrier layer, a polyvinylidene chloride resin layer laminated by coating on a plastic film surface. However, in recent years, there has been a strong demand for development of non-chlorine gas barrier packaging films to avoid problems with hydrogen chloride gas, dioxins, etc. generated during incineration.

Examples of non-chlorine gas barrier packaging films include films prepared from gas barrier resins such as ethylene-vinyl alcohol copolymers and polyvinyl alcohols. However, these films have limited use because they have reduced gas barrier properties at high humidity.

### DISCLOSURE OF THE INVENTION

An object of the present invention is to provide a novel gas barrier film that have excellent barrier properties to gases such as oxygen, carbonic acid gas and water vapor, good UV screening properties, good flavor retention properties and high transparency.

Other objects and features of the invention will become apparent from the following description.

The invention provides the following novel gas barrier films:

1. A gas barrier film comprising at least one titanium oxide film layer (B) laminated on one or both sides of a plastic film layer (A).

2. A film according to item 1, wherein the titanium oxide film layer (B) is laminated by:
applying, to the plastic film layer (A), a titanium oxide film-forming coating material made of a titanium-containing aqueous liquid (a) obtained by mixing at least one titanium compound selected from the group consisting of hydrolyzable titanium compounds, low condensates of hydrolyzable titanium compounds, titanium hydroxide and low condensates of titanium hydroxide with aqueous hydrogen peroxide; and
drying the coating material at a temperature not higher than 200° C.

3. A film according to item 2, wherein the titanium-containing aqueous liquid (a) is an aqueous peroxo titanic acid solution obtained by mixing a hydrolyzable titanium compound and/or its low condensate with aqueous hydrogen peroxide.

4. A film according to item 3, wherein the hydrolyzable titanium compound is a tetraalkoxytitanium represented by the formula
Ti(OR)₄ (1)
wherein Rs are the same or different and each represent C₁ to C₅ alkyl.

5. A film according to item 3, wherein the low condensate of a hydrolyzable titanium compound is a compound having a condensation degree of 2 to 30 and obtained by self-condensing a tetraalkoxytitanium represented by the formula
Ti(OR)₄ (1)
wherein Rs are the same or different and each represent C₁ to C₅ alkyl.

6. A film according to item 3, wherein the proportion of the aqueous hydrogen peroxide is 0.1 to 100 parts by weight calculated as hydrogen peroxide, per 10 parts by weight of the hydrolyzable titanium compound and/or its low condensate.

7. A film according to item 3, wherein the titanium-containing aqueous liquid (a) is an aqueous peroxo titanic acid solution obtained by mixing a hydrolyzable titanium compound and/or its low condensate with aqueous hydrogen peroxide in the presence of a titanium oxide sol.

8. A film according to item 7, wherein the titanium oxide sol is an aqueous dispersion of anatase titanium oxide.

9. A film according to item 7, wherein the proportion of the titanium oxide sol is 0.01 to 10 parts by weight as solids, per 1 part by weight of the hydrolyzable titanium compound and/or its low condensate.

10. A film according to item 1, wherein the titanium oxide film layer (B) is laminated by:
applying, to the plastic film layer (A), a titanium oxide film-forming coating material comprising a titanium-containing aqueous liquid (a) obtained by mixing at least one titanium compound selected from the group consisting of hydrolyzable titanium compounds, low condensates of hydrolyzable titanium compounds, titanium hydroxide and low condensates of titanium hydroxide with aqueous hydrogen peroxide, an organic basic compound (b) and an aqueous organic high molecular compound (c) stable at a pH not higher than 10; and
drying the coating material at a temperature not lower than 200° C.

11. A film according to item 10, wherein the titanium-containing aqueous liquid (a) is an aqueous peroxo titanic acid solution obtained by mixing a hydrolyzable titanium compound and/or its low condensate with aqueous hydrogen peroxide.

12. A film according to item 11, wherein the hydrolyzable titanium compound is a tetraalkoxytitanium represented by the formula
Ti(OR)₄ (1)
wherein Rs are the same or different and each represent C₁ to C₅ alkyl.

13. A film according to item 11, wherein the low condensate of a hydrolyzable titanium compound is a compound having a condensation degree of 2 to 30 and obtained by self-condensing a tetraalkoxytitanium represented by the formula
Ti(OR)₄ (1)
wherein Rs are the same or different and each represent C₁ to C₅ alkyl.

14. A film according to item 11, wherein the proportion of the aqueous hydrogen peroxide is 0.1 to 100 parts by weight, per 10 parts by weight of the hydrolyzable titanium compound and/or its low condensate.

15. A film according to item 11, wherein the titanium-containing aqueous liquid (a) is an aqueous peroxo titanic acid solution obtained by mixing a hydrolyzable titanium compound and/or its low condensate with aqueous hydrogen peroxide in the presence of a titanium oxide sol.

16. A film according to item 15, wherein the titanium oxide sol is an aqueous dispersion of anatase titanium oxide.

17. A film according to item 15, wherein the proportion of the titanium oxide sol is 0.01 to 10 parts by weight as solids, per 1 part by weight of the hydrolyzable titanium compound and/or its low condensate.

18. A film according to item 10, wherein the organic basic compound (b) has a boiling point not higher than 300° C.

19. A film according to item 10, wherein the proportion of the organic basic compound (b) is 0.001 to 10 parts by weight, per 100 parts by weight of the solids in the titanium-containing aqueous liquid (a).

20. A film according to item 10, wherein the aqueous organic high molecular compound (c) is at least one resin selected from the group consisting of epoxy resins, phenol resins, acrylic resins, urethane resins, polyester resins, polyvinyl alcohol resins, polyoxyalkylene chain-containing resins and olefin-polymerizable unsaturated carboxylic acid copolymer resins.

21. A film according to item 10, wherein the proportion of the aqueous organic high molecular compound (c) is 0.1 to 200 parts by weight per 100 parts by weight of the solids in the titanium-containing aqueous liquid (a).

22. A film according to item 10, wherein the titanium oxide film-forming coating material is an aqueous coating material of pH 2 to 10.

23. A film according to item 1, wherein part or all of the titanium oxide of the layer (B) is amorphous titanium oxide.

24. A film according to item 1, wherein the plastic film layer (A) is a food packaging plastic film layer.

25. A film according to item 1 or 24, wherein the plastic film layer (A) is a polypropylene film layer.

26. A film according to item 1, wherein the plastic film layer (A) is 5 to 100 μm thick.

27. A film according to item 1, wherein the titanium oxide film layer (B) is 0.001 to 10 μm thick.

The present inventors carried out extensive research to achieve the above object. As a result, they found that, when a titanium oxide film layer (B) is laminated as a gas barrier film on one or both sides of a plastic film layer (A), a novel gas barrier film is obtained which has high barrier properties to gases such as oxygen, carbonic acid gas and water vapor, and is excellent in UV screening properties, flavor retention properties, transparency and the like. They further found that the titanium oxide film layer (B) can be preferably formed by: applying, to the plastic film layer (A), a titanium oxide film-forming coating material made of a specific aqueous liquid (a), or a titanium oxide film-forming coating material comprising the aqueous liquid (a), an organic basic compound (b) and an aqueous organic high molecular compound (c); and then drying the coating material.

The present invention has been accomplished based on these novel findings.

Plastic Film Layer (A)

The plastic film layer (A) in the film of the invention may be any known plastic film substrate used for packaging or like purposes and capable of fixing and retaining the titanium oxide film layer (B).

The film layer (A) is made of, for example, polyethylene, polypropylene, polyisobutylene, polybutadiene, polyvinyl acetate, polyvinyl chloride, polyethylene terephthalate (PET), nylon, polystyrene, polyurethane, polycarbonate (PC), polyvinyl alcohol (PVA), ethylene-vinyl alcohol copolymer, polyacetal, AS resin, ABS resin, melamine resin, acrylic resin, epoxy resin, polyester resin or like thermoplastic. For food packaging, polypropylene and polyethylene terephthalate are particularly preferable from the viewpoints of processiblility, safety, hygiene, etc.

The plastic film layer (A) may optionally contain an ultraviolet absorber, a filler, a heat stabilizer, a coloring agent or the like. The film layer (A) may be surface-treated with, for example, a corona discharge. Further, the surface of the film layer (A) may be colored or patterned with ink or paint.

The plastic film layer (A) is usually about 5 to 100 μm thick, preferably 20 to 80 μm thick.

Titanium Oxide Film Layer (B)

The titanium oxide film layer (B) laminated on the plastic film layer (A) is excellent in gas barrier properties, UV screening properties, flavor retention properties and transparency.

The titanium oxide film layer (B) can be formed preferably by applying, to one or both sides of the plastic film layer (A), a titanium oxide film-forming coating material made of the specific aqueous liquid (a), or a titanium oxide film-forming coating material comprising the aqueous liquid (a), an organic basic compound (b) and an aqueous organic high molecular compound (c), and then drying the coating material.

The titanium-containing aqueous liquid (a) for use in the titanium oxide film-forming coating material may be a known titanium-containing aqueous liquid obtained by mixing at least one titanium compound selected from the group consisting of hydrolyzable titanium compounds, low condensates of hydrolyzable titanium compounds, titanium hydroxide and low condensates of titanium hydroxide with aqueous hydrogen peroxide.

The hydrolyzable titanium compounds are titanium compounds containing hydrolyzable groups bonded directly to a titanium atom. The compounds produce titanium hydroxide by reaction with water, water vapor or the like. In the hydrolyzable titanium compounds, all the groups bonded to the titanium atom may be hydrolyzable groups, or part of the groups may be hydroxyl groups formed by hydrolysis of hydrolyzable groups.

The hydrolyzable groups may be any groups capable of producing hydroxyl groups by reaction with water. Examples of such groups include lower alkoxyl and groups forming salts with titanium atoms. Examples of the groups forming salts with titanium atoms include halogen atoms (e.g., chlorine atoms), hydrogen atoms and sulfuric acid ions.

Examples of hydrolyzable titanium compounds containing lower alkoxyl groups as hydrolyzable groups include tetraalkoxytitaniums.

Typical examples of hydrolyzable titanium compounds containing, as hydrolyzable groups, groups forming salts with titanium include titanium chloride and titanium sulfate.

The low condensates of hydrolyzable titanium compounds are products of low self-condensation of a hydrolyzable titanium compound. In the low condensates, all the groups bonded to the titanium atom may be hydrolyzable groups, or part of the groups may be hydroxyl groups formed by hydrolysis of hydrolyzable groups.

Examples of low condensates of titanium hydroxide include orthotitanic acid (titanium hydroxide gel) obtained by reaction of an aqueous solution of titanium chloride, titanium sulfate or the like with an aqueous solution of an alkali such as ammonia or caustic soda.

The low condensates of hydrolyzable titanium compounds or low condensates of titanium hydroxide have a condensation degree of preferably 2 to 30, particularly 2 to 10.

The aqueous liquid (a) may be any known titanium-containing aqueous liquid obtained by reaction of any of the above titanium compounds with aqueous hydrogen peroxide. Specific examples of such aqueous liquids include the following:

(1) Aqueous peroxo titanic acid solutions described in Japanese Unexamined Patent Publications No. 1988-35419 and No. 1989-224220, obtained by adding aqueous hydrogen peroxide to a gel or sol of hydrous titanium oxide,

(2) Yellow, transparent, viscous titanium oxide film-forming aqueous liquids described in Japanese Unexamined Patent Publications No. 1997-71418 and No. 1998-67516, obtained by: reacting an aqueous solution of titanium chloride, titanium sulfate or the like with an aqueous solution of an alkali such as ammonia or caustic soda to precipitate a titanium hydroxide gel called orthotitanic acid; isolating the titanium hydroxide gel by decantation; washing the isolated gel; and adding aqueous hydrogen peroxide to the gel,

(3) Titanium oxide film-forming aqueous liquids described in Japanese Unexamined Patent Publications No. 2000-247638 and 2000-247639, obtained by: adding aqueous hydrogen peroxide to an aqueous solution of an inorganic titanium compound such as titanium chloride or titanium sulfate to prepare a peroxo titanium hydrate; adding a basic substance to the peroxo titanium hydrate; allowing to stand or heating the resulting solution to precipitate a peroxo titanium hydrate polymer; removing dissolved components other than water; and allowing hydrogen peroxide to act.

Preferably, the titanium-containing aqueous liquid (a) is an aqueous peroxo titanic acid solution (a1) obtained by mixing a hydrolyzable titanium compound and/or its low condensate with aqueous hydrogen peroxide.

A particularly preferred example of the titanium compounds is a tetraalkoxytitanium represented by the formula
Ti(OR)₄ (1)
wherein Rs are the same or different and each represent C₁ to C₅ alkyl. Examples of C₁ to C₅ alkyl include methyl, ethyl, n-propyl, isopropyl, n-butyl, isobutyl, sec-butyl and tert-butyl.

The low condensates of titanium compounds are preferably self-condensates of the compounds of the formula (1) having a condensation degree of 2 to 30, preferably 2 to 10.

The proportion of aqueous hydrogen peroxide is preferably 0.1 to 100 parts by weight, particularly 1 to 20 parts by weight, calculated as hydrogen peroxide, per 10 parts of a hydrolyzable titanium compound of the formula (1) and/or its low condensate (hereinafter the compound and/or its low condensate is referred to simply as “hydrolyzable titanium compound (I)”). Less than 0.1 part by weight of aqueous hydrogen peroxide (calculated as hydrogen peroxide) will result in insufficient formation of peroxo titanic acid, producing opaque precipitates. On the other hand, if more than 100 parts by weight (calculated as hydrogen peroxide) of aqueous hydrogen peroxide is used, it is likely that part of hydrogen peroxide remains unreacted and emits hazardous active oxygen during storage.

The hydrogen peroxide concentration in the aqueous hydrogen peroxide is not limited, but is preferably 3 to 40 wt. %, considering ease of handling.

The aqueous peroxo titanic acid solution can be prepared usually by mixing the hydrolyzable titanium compound (I) with aqueous hydrogen peroxide with stirring at about 1 to 70° C. for about 10 minutes to 20 hours. If necessary, methanol, ethanol, n-propanol, isopropanol, ethylene glycol monobutyl ether, propylene glycol monomethyl ether or like water-soluble solvent may be also mixed.

Presumably, the aqueous peroxo titanic acid solution (a1) is obtained through the following mechanism: When the hydrolyzable titanium compound (I) is mixed with aqueous hydrogen peroxide, the compound is hydrolyzed with water and formed into a hydroxyl-containing titanium compound. Immediately thereafter, hydrogen peroxide is coordinated to the hydroxyl-containing titanium compound to thereby form peroxo titanic acid. The aqueous peroxo titanic acid solution is highly stable at room temperature and durable for long-term storage.

Also preferred is an aqueous peroxo titanic acid solution (a2) obtained by mixing the hydrolyzable titanium compound (I) with aqueous hydrogen peroxide in the presence of a titanium oxide sol, since the solution has improved storage stability and is capable of forming a titanium oxide film improved in UV screening properties, corrosion resistance and other properties. The reason for the improvements is presumed as follows: During preparation of the aqueous solution, the hydrolyzable titanium compound (I) is adsorbed on the titanium oxide sol particles and chemically bonded to hydroxyl groups generated on the particles surface by condensation. Further, the hydrolyzable titanium compound undergoes self-condensation and is converted into a high molecular compound. The high molecular compound is mixed with aqueous hydrogen peroxide, thereby giving a stable aqueous peroxo titanic acid solution remarkably free of gelation and thickening during storage.

The titanium oxide sol comprises amorphous titanium oxide particles or anatase titanium oxide particles dispersed in water. As the titanium oxide sol, an aqueous dispersion of anatase titanium oxide is preferred from the viewpoint of UV screening properties. The titanium oxide sol may contain, in addition to water, an aqueous organic solvent such as an alcohol solvent or an alcohol ether solvent.

The titanium oxide sol may be known one, such as a dispersion of amorphous titanium oxide particles obtained by dispersing titanium oxide agglomerates in water, or a dispersion in water of anatase titanium oxide particles obtained by calcining titanium oxide agglomerates. Amorphous titanium oxide can be converted into anatase titanium oxide by calcining at a temperature not lower than the anatase crystallization temperature, usually at a temperature not lower than 200° C. Examples of titanium oxide agglomerates include (1) agglomerates obtained by hydrolysis of an inorganic titanium compound such as titanium sulfate or titanyl sulfate, (2) agglomerates obtained by hydrolysis of an organic titanium compound such as titanium alkoxide, (3) agglomerates obtained by hydrolysis or neutralization of a solution of titanium halide such as titanium tetrachloride.

Commercially available titanium oxide sols include, for example, “TKS-201” (a tradename of TEICA Corp., an aqueous sol of anatase titanium oxide particles having an average particle size 6 nm), “TKS-203” (a tradename of TEICA Corp., an aqueous sol of anatase titanium oxide particles having an average particle size of 6 nm), “TA-15” (a tradename of Nissan Chemical Industries, Ltd., an aqueous sol of anatase titanium oxide particles), and “STS-11” (a tradename of Ishihara Sangyo Kaisha, Ltd., an aqueous sol of anatase titanium oxide particles).

The amount of the titanium oxide sol used when mixing the hydrolyzable titanium compound (I) and aqueous hydrogen peroxide is, as solids, usually 0.01 to 10 parts by weight, preferably 0.1 to 8 parts by weight, per 1 part by weight of the hydrolyzable titanium compound (I). Less than 0.01 part by weight of the titanium oxide sol fails to achieve the effect of adding a titanium oxide sol, i.e., improvement of storage stability of the coating material and UV screening properties of the titanium oxide film. On the other hand, more than 10 parts by weight of the sol impairs the film-forming properties of the coating material.

The titanium-containing aqueous liquid (a) may be used in the form of a dispersion of titanium oxide particles with an average particle size not greater than 10 nm. Such a dispersion can be prepared by mixing the hydrolyzable titanium compound (I) with aqueous hydrogen peroxide optionally in the presence of the titanium oxide sol, and then subjecting the resulting peroxo titanic acid aqueous solution to heat treatment or autoclave treatment at a temperature not lower than 80° C. The dispersion usually has a translucent appearance.

When the heat treatment or autoclave treatment is carried out at a temperature lower than 80° C., the crystallization of titanium oxide does not proceed sufficiently. The titanium oxide particles obtained by heat treatment or autoclave treatment have a particle size not greater than 10 nm, preferably a particle size of 1 nm to 6 nm. If the titanium oxide particles have a particle size greater than 10 nm, the resulting coating material has such a low film-forming properties that a film with a thickness of 1 μm or greater will develop cracks.

The titanium-containing aqueous liquid (a) used as a titanium oxide film-forming coating material is applied to a plastic film and dried by heating at a temperature not higher than 200° C. to prepare a compact titanium oxide film having good adhesion. The lower limit of the drying temperature is not restricted. For example, the aqueous solution may be dried at room temperature.

When the aqueous solution (a1) is used as the titanium-containing aqueous liquid (a), the solution usually forms an amorphous titanium oxide film containing a slight amount of hydroxyl groups, when dried under the above condition. The amorphous titanium oxide film has advantageous such as higher gas barrier properties and higher transparency. When the titanium-containing aqueous solution (a2) is used, the solution usually forms an anatase titanium oxide film containing a slight amount of hydroxyl groups, when dried under the above condition.

When the titanium oxide film-forming coating material comprises a titanium-containing aqueous liquid (a), an organic basic compound (b) and an aqueous organic high molecular compound (c) stable at a pH not higher than 10, the coating material forms a film improved in adhesion to the plastic film layer (A) and is capable of giving a gas barrier film whose gas barrier properties are hardly reduced by friction or bending during processing and distribution.

The titanium-containing aqueous liquid (a) to be used in combination with the organic basic compound (b) and the aqueous organic high molecular compound (c) may be any of the titanium-containing aqueous solutions mentioned above.

As the organic basic compound (b), any neutralizable organic basic compound having a boiling point not higher than 300° C. can be used without limitation. Particularly preferred examples include ammonia, diethylethanolamine, 2-amino-2-methyl-1-propanol, triethylamine and morpholine.

The amount of the organic basic compound (b) to be used is 0.001 to 10 parts by weight, preferably 0.005 to 5 parts by weight, per 100 parts by weight of the solids in the titanium-containing aqueous liquid (a). The organic basic compound (b), if used in an amount less than the specified range, does not show sufficient effect. If the organic basic compound (b) is used in an amount greater than the specified range, a large proportion of the organic basic compound (b) remains in the resulting film, and is likely to reduce the film-forming properties, gas barrier properties, corrosion resistance and like properties.

The aqueous organic high molecular compound (c) is not limited as long as it is capable of stably dissolving or dispersing in water at a pH not higher than 10.

The aqueous organic high molecular compound (c) may be in the form of an aqueous solution, an aqueous dispersion or an emulsion. The compound can be solubilized, dispersed or emulsified in water by known methods.

Specific examples of the aqueous organic high molecular compound (c) include compounds having functional groups (e.g., at least one of hydroxyl, carboxyl, amino, imino, sulfide, phosphine and the like) which are by themselves capable of solubilizing or dispersing the compounds in water, and such compounds in which part or all of the functional groups have been neutralized. When the compound (c) is an acid resin such as a carboxyl-containing resin, the compound can be neutralized with ethanol amine, triethylamine or like amine compound; aqueous ammonia; lithium hydroxide, sodium hydroxide, potassium hydroxide or like alkali metal hydroxide; or the like. When the compound (c) is a basic resin such as an amino-containing resin, the compound can be neutralized with acetic acid, lactic acid or like fatty acid; phosphoric acid or like mineral acid; or the like.

Examples of the aqueous organic high molecular compound (c) include epoxy resins, phenol resins, acrylic resins, urethane resins, polyester resins, polyvinyl alcohol resins, polyoxyalkylene chain-containing resins, olefin-polymerizable unsaturated carboxylic acid copolymer resins, nylon resins, polyglycerin, carboxymethyl cellulose, hydroxymethyl cellulose and hydroxyethyl cellulose.

The aqueous organic high molecular compound (c) is preferably an epoxy resin, a phenol resin, an acrylic resin, a urethane resin, a polyester resin, a polyvinyl alcohol resin, a polyoxyalkylene chain-containing resin, an olefin-polymerizable unsaturated carboxylic acid copolymer resin or the like. In particular, an epoxy resin, a polyester resin, a urethane resin, a phenol resin or the like is preferably usable.

Preferred examples of epoxy resins include cationic epoxy resins obtained by addition of amine to epoxy resins; and modified epoxy resins such as acrylic modified epoxy resins and urethane modified epoxy resins. Examples of cationic epoxy resins include adducts of epoxy compounds with primary mono- or polyamines, secondary mono- or polyamines, mixtures of primary and secondary polyamines (see, for example, U.S. Pat. No. 3,984,299); adducts of epoxy compounds with secondary mono- or polyamines having ketiminized primary amino groups (see, for example, U.S. Pat. No. 4,017,438); and etherification reaction products of epoxy compounds with hydroxyl compounds having ketiminized primary amino groups (see, for example, Japanese Unexamined Patent Publication No. 1984-43013).

Preferred epoxy compounds include those having a number average molecular weight of 400 to 4,000, particularly 800 to 2,000, and an epoxy equivalent weight of 190 to 2,000, particularly 400 to 1,000. Such epoxy compounds can be obtained by, for example, reaction of a polyphenol compound with epichlorohydrin. Examples of polyphenol compounds include bis(4-hydroxyphenyl)-2,2-propane, 4,4-dihydroxybenzophenone, bis(4-hydroxyphenyl)-1,1-ethane, bis(4-hydroxyphenyl)-1,1-isobutane, bis(4-hydroxy-tert-butylphenyl)-2,2-propane, bis(2-hydroxy-naphthyl)methane, 1,5-dihydroxynaphthalene, bis(2,4-dihydroxyphenyl)methane, tetra(4-hydroxyphenyl)-1,1,2,2-ethane, 4,4-dihydroxydiphenylsulfone, phenol novolac and cresol novolac.

Preferred phenol resins include those prepared by water-solubilizing a high molecular compound obtained by addition and condensation of a phenol component and a formaldehyde by heating in the presence of a reaction catalyst. Usable as the starting phenol component is a bifunctional phenol compound, a trifunctional phenol compound, a tetra- or higher functional phenol compound or the like. Examples of bifunctional phenol compounds include o-cresol, p-cresol, p-tert-butyl phenol, p-ethyl phenol, 2,3-xylenol and 2,5-xylenol. Examples of trifunctional phenol compounds include phenol, m-cresol, m-ethyl phenol, 3,5-xylenol and m-methoxy phenol. Examples of tetrafunctional phenol compounds include bisphenol A and bisphenol F. These phenol compounds may be used either singly or in combination.

Preferred acrylic resins include, for example, homopolymers or copolymers of monomers having hydrophilic groups such as carboxyl, amino or hydroxyl, and copolymers of hydrophilic group-containing monomers with other copolymerizable monomers. These resins are obtained by emulsification polymerization, suspension polymerization or solution polymerization, optionally followed by neutralization or conversion to aqueous resins. The resulting resin may be further modified, if required.

Examples of carboxyl-containing monomers include acrylic acid, methacrylic acid, maleic acid, maleic anhydride, crotonic acid and itaconic acid.

Examples of nitrogen-containing monomers include N,N-dimethylaminoethyl(meth)acrylate, N,N-diethylaminoethyl(meth)acrylate, N-t-butylaminoethyl(meth)acrylate and like nitrogen-containing alkyl(meth)acrylates; acrylamide, methacrylamide, N-methyl(meth)acrylamide, N-ethyl (meth)acrylamide, N-methylol(meth)acrylamide, N-methoxymethyl (meth)acrylamide, N-butoxymethyl(meth)acrylamide, N,N-dimethyl(meth)acrylamide, N,N-dimethylaminopropyl(meth)acrylamide, N,N-dimethylaminoethyl(meth)acrylamide and like polymerizable amides; 2-vinylpyridine, 1-vinyl-2-pyrolidone, 4-vinylpyridine and like aromatic nitrogen-containing monomers; and allyl amines.

Examples of hydroxyl-containing monomers include 2-hydroxyethyl(meth)acrylate, hydroxypropyl(meth)acrylate, 2,3-dihydroxybutyl(meth)acrylate, 4-hydroxybutyl(meth)acrylate, polyethylene glycol mono(meth)acrylate and like monoesters of polyhydric alcohols with acrylic acids or methacrylic acids; and compounds obtained by subjecting monoesters of polyhydric alcohols and acrylic acids or methacrylic acids to ring-opening polymerization with ε-caprolactone.

Other polymerizable monomers include, for example, methyl(meth)acrylate, ethyl(meth)acrylate, n-propyl(meth)acrylate, isopropyl(meth)acrylate, n-butyl(meth)acrylate, isobutyl(meth)acrylate, tert-butyl(meth)acrylate, 2-ethylhexyl (meth)acrylate, n-octyl(meth)acrylate, lauryl (meth)acrylate, tridecyl(meth)acrylate, octadecyl(meth)acrylate, isostearyl(meth)acrylate and like C₁ to C₂₄ alkyl(meth)acrylates; styrene; and vinyl acetate. These compounds may be used either singly or in combination.

As used herein, the term “(meth)acrylate” is intended to mean acrylate or methacrylate.

Preferred urethane resins include those prepared by: subjecting polyurethane resins obtained from polyols (e.g., polyester polyol and polyther polyol) and diisocyanate to chain extension optionally in the presence of, as a chain extender, a low molecular compound having at least two active hydrogen atoms, such as diol or diamine; and then dispersing or dissolving the urethane resins stably in water. Such urethane resins are disclosed in, for example, Japanese Examined Patent Publications No. 1967-24192, No. 1967-24194, No. 1967-5118, No. 1974-986, No. 1974-33104, No. 1975-15027 and No. 1978-29175.

The polyurethane resins can be dispersed or dissolved stably in water by the following methods:

(1) Introduce an ionic group such as hydroxyl, amino or carboxyl into the side chain or the terminal of a polyurethane resin to impart hydrophilicity to the resin; and disperse or dissolve the resin in water by self-emulsification.

(2) Disperse a polyurethane resin that has completed reaction or a polyurethane resin whose terminal isocyanate group is blocked with a blocking agent, forcibly in water using an emulsifier and mechanical shear force. Examples of usable blocking agents include oximes, alcohols, phenols, mercaptans, amines and sodium bisulfite.

(3) Mix an isocyanate-terminated polyurethane resin, water, an emulsifier and a chain extender; and using mechanical share force, disperse the resin while converting the resin into a high molecular resin.

(4) Disperse or dissolve in water a polyurethane resin prepared using, as a starting polyol, a water-soluble polyol such as polyethylene glycol.

The aqueous resins prepared by dispersing or dissolving a polyurethane resin by the above methods can be used either singly or in combination.

Diisocyanates usable for the synthesis of the polyurethane resins include aromatic, alicyclic and aliphatic diisocyanates. Specific examples of these diisocyanates include hexamethylene diisocyanate, tetramethylene diisocyanate, 3,3′-dimethoxy-4,4′-biphenylene diisocyanate, p-xylylene diisocyanate, m-xylylene diisocyanate, 1,3-(diisocyanatomethyl)cyclohexanone, 1,4-(diisocyanatomethyl)cyclohexanone, 4,4′-diisocyanato cyclohexanone, 4,4′-methylenebis(cyclohexyl isocyanate), isophorone diisocyanate, 2,4-tolylene diisocyanate, 2,6-tolylene diisocyanate, p-phenylene diisocyanate, diphenylmethane diisocyanate, m-phenylene diisocyanate, 2,4-naphthalene diisocyanate, 3,3′-dimethyl-4,4′-biphenylene diisocyanate and 4,4′-biphenylene diisocyanate. Among them, particularly preferred are 2,4-tolylene diisocyanate, 2,6-tolylene diisocyanate, hexamethylene diisocyanate and isophorone diisocyanate.

Commercial products of the polyurethane resins include, for example, “Hydran HW-330”, “Hydran HW-340” and “Hydran HW-350” (tradenames of Dainippon Ink and Chemicals, Inc.), and “Superflex 100”, “Superflex 150” and “Superflex F-3438D” (tradenames of Dai-ichi Kogyo Seiyaku Co., Ltd.).

Preferred polyvinyl alcohol resins are those having a saponification degree not lower than 87%, in particular so-called completely saponified polyvinyl alcohols having a saponification degree not lower than 98%. Further, the resins preferably have a number average molecular weight of 3,000 to 100,000.

Usable polyoxyalkylene chain-containing resins include resins containing polyoxyethylene chains or polyoxypropylene chains. Examples of such resins include polyethylene glycol, polypropylene glycol, blocked polyoxyalkylene glycol comprising polyoxyethylene chains and polyoxypropylene chains are bonded to form blocks.

Preferred as the olefin-polymerizable unsaturated carboxylic acid copolymer resin is at least one of two types of water-dispersible or water-soluble resins, i.e., (i) a copolymer of ethylene, propylene or like olefin and (meth)acrylic acid, maleic acid or like polymerizable unsaturated carboxylic acid, and (ii) a resin obtained by adding a polymerizable unsaturated compound to an aqueous dispersion of the above copolymer for emulsification polymerization followed by intraparticle crosslinking.

The copolymer (i) is a copolymer of at least one olefin and at least one polymerizable unsaturated carboxylic acid. It is preferable that the copolymer comprises, as a monomer component, 3 to 60 wt. %, preferably 5 to 40 wt. %, of unsaturated carboxylic acid or acids. The copolymer can be dispersed in water by neutralizing acid groups in the copolymer with a basic substance.

The polymerizable unsaturated compound to be added to an aqueous dispersion of the copolymer (i) for emulsification polymerization and crosslinking to prepare an intraparticle crosslinked resin (ii) may be, for example, any of the vinyl monomers listed above in the description of the water-dispersible or water-soluble acrylic resins. These vinyl monomers can be used either singly or in combination.

The proportion of the aqueous organic high molecular compound (c) is preferably 0.1 to 200 parts by weight, particularly 1 to 50 parts by weight, per 100 parts by weight of the solids in the titanium-containing aqueous liquid (a), from the viewpoints of stability of the coating material, and gas barrier properties, UV screening properties, flavor retention properties and processing resistance of the titanium oxide film.

The titanium oxide film-forming coating material comprising the titanium-containing aqueous liquid (a), the organic basic compound (b) and the aqueous organic high molecular compound (c) stable at a pH not higher than 10 is preferably an aqueous coating material of pH 2 to 10. A coating material having a pH less than 2 is liable to have reduced storage stability, whereas a coating material having a pH higher than 10 is likely to produce precipitates and have lowered film-forming properties.

The titanium oxide film-forming coating material may optionally contain additives, such as commercially available titanium oxide sols, titanium oxide powders and pigments. Usable pigments include, for example, mica, talc, silica, barium sulfate and clay.

The titanium oxide film layer (B) is preferably 0.001 to 10 μm thick, more preferably 0.1 to 3 μm thick. A thickness less than 0.001 μm reduces barrier properties to gases such as oxygen, carbonic acid and water vapor, and flavor retention properties. On the other hand, a thickness greater than 10 μm renders the titanium oxide film brittle, thus lowering gas barrier properties and flavor retention properties.

Preparation, Layer Structure and use of the Gas Barrier Film

The gas barrier film of the invention can be prepared by, for example, applying the titanium oxide film-forming coating material to at least one surface of the plastic film layer (A), and then drying the material at room temperature or by heating at a temperature not higher than 200° C., preferably not higher than 150° C., to form a titanium oxide film layer (B). During drying, the titanium oxide film may be cured. If the heating temperature is over 200° C., the plastic film layer (A) may develop deterioration such as deformation or change in properties.

The titanium oxide film-forming coating material can be applied by conventional processes including coating processes such as roller coating, dip coating, spray coating and brush coating and, printing processes such as screen printing and relief printing.

The titanium oxide film-forming coating material is applied to one or both sides of the plastic film layer (A) and dried to obtain a two-layer laminate film consisting of a plastic film layer (A) and a titanium oxide film layer (B) or a three-layer laminate film consisting of a titanium oxide film layer (B), a plastic film layer (A) and a titanium oxide film layer (B). As described above, the plastic film layer (A) is usually about 5 to 100 μm thick, and the titanium oxide film layer (B) is usually 0.001 to 10 μm thick. The total thickness of the two-layer or three-layer laminate film is usually about 7 to 100 μm.

The two-layer or three-layer laminate film of the invention may have, on one or both sides thereof, a hard coat layer, a scratch-proof layer, a heat seal layer or an adhesive layer, by conventional processes.

The gas barrier film of the invention is particularly suitable for uses that require barrier properties to gases such as oxygen, carbonic acid gas and water vapor, UV screening properties, flavor retention properties and transparency.

Specifically stated, the film of the invention is useful for containers or packages of various products, in industries such as foods, pharmaceuticals, medical treatment, electrical components, agriculture and fisheries, fermentation and household goods. In particular, the film of the invention is suitable for containers or packages of foods and beverages, since the film is capable of effectively preventing transfer of oxygen and flavors dissolved in water, beverages or foods, and infiltration of oxygen in air and other gases into the containers or packages.

### BRIEF DESCRIPTION OF THE DRAWINGS

FIG. 1 shows the result of X-ray diffraction of the titanium oxide film-forming coating material (1) obtained in Production Example 1.

### BEST MODE FOR CARRYING OUT THE INVENTION

The following Production Examples, Examples and Comparative Examples are provided to illustrate the present invention in further detail, and are not intended to limit the scope of the claims herein. In these examples, parts and percentages are all by weight.

Laminate Films Prepared using Titanium-Containing Aqueous Solution (a1) as Coating Material

### PRODUCTION EXAMPLE 1

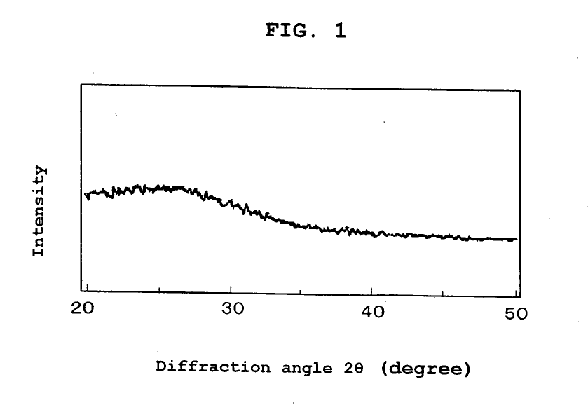

A mixture of 10 parts of tetraisopropoxy titanium and 10 parts of isopropanol was added dropwise to a mixture of 10 parts of 30% aqueous hydrogen peroxide and 100 parts of deionized water, at 20° C. with stirring over 1 hour. Thereafter, the resulting mixture was aged at 25° C. for 2 hours, giving a yellow, transparent, slightly viscous an aqueous peroxo titanic acid solution (a titanium-containing aqueous solution) having a solid content of 2%. This solution was used as titanium oxide film-forming coating material (1). The result of X-ray diffraction of coating material (1) is shown in FIG. 1. FIG. 1 reveals that titanium oxide in the coating material is amorphous titanium oxide.

### PRODUCTION EXAMPLE 2

The procedure of Production Example 1 was repeated except that 10 parts of tetra-n-butoxy titanium is used in place of tetraisopropoxy titanium, giving a titanium-containing aqueous solution having a solid content of 2%. This solution was used as titanium oxide film-forming coating material (2).

### PRODUCTION EXAMPLE 3

The procedure of Production Example 1 was repeated except that 10 parts of trimer of tetraisopropoxy titanium was used in place of tetraisopropoxy titanium, giving a titanium-containing aqueous solution having a solid content of 2%. This solution was used as titanium oxide film-forming coating material (3).

### PRODUCTION EXAMPLE 4

The procedure of Production Example 1 was repeated with the exception that a 3 times greater amount of aqueous hydrogen peroxide was used, the dropwise addition was carried out at 50° C. over 1 hour and the subsequent aging was carried out at 60° C. for 3 hours. In this manner, a titanium-containing aqueous solution having a solid content of 2%. This solution was used as titanium oxide film-forming coating material (4).

### PRODUCTION EXAMPLE 5

Coating material (2) obtained in Production Example 2 was heated at 95° C. for 6 hours, giving a whitish yellow, translucent dispersion of titanium oxide (a titanium-containing aqueous solution) having a solid content of 2%. This dispersion was used as titanium oxide film-forming coating material (5).

### PRODUCTION EXAMPLE 6

10% aqueous ammonia was added dropwise to 500 cc of an aqueous solution obtained by diluting 5 cc of a 60% aqueous titanium tetrachloride solution with distilled water, to precipitate titanium hydroxide. The precipitates were washed with distilled water, mixed with 10 cc of a 30% aqueous hydrogen peroxide solution and stirred, giving 70 cc of a yellow, translucent, viscous liquid containing peroxo titanic acid (a titanium-containing aqueous solution) having a solid content of 2%. This liquid was used as titanium oxide film-forming coating material (6).

### PRODUCTION EXAMPLE 7

Titanium hydroxide was dispersed in water to a concentration of 0.2 mol/l. The obtained dispersion was used as comparative titanium oxide film-forming coating material (7).

### EXAMPLES 1 TO 6 AND COMPARATIVE EXAMPLE 1

Titanium oxide film-forming coating materials (1) to (7) were each applied to a dry thickness of 0.3 μm using a bar coater, to a corona discharge-treated surface of a biaxially oriented polypropylene film with a thickness of 20 μm. The coating materials were then dried at 120° C. for 5 minutes to form titanium oxide films. Thus, laminate films of Examples 1 to 6 were prepared using coating materials (1) to (6), respectively, and a laminate film of Comparative Example 1 was prepared using coating material (7).

### COMPARATIVE EXAMPLES 2 AND 3

A 20 μm thick biaxially oriented polypropylene film and a 20 μm thick biaxially oriented copolymerized polyethylene terephthalate film were used as films of Comparative Examples 2 and 3, respectively.

The films of Examples 1 to 6 and Comparative Examples 1 to 3 were tested for titanium oxide film condition, adhesion, pencil hardness and oxygen permeability, by the following methods:

(1) Titanium oxide film condition: The titanium oxide films were checked for smoothness, transparency and abnormalities such as cracks, with the naked eye. Films without abnormalities were rated good.

(2) Adhesion: According to JIS K5400 8.5.2 (1990), a cross cut tape test was carried out. Specifically, 100 squares (1 mm×1 mm) were formed on the surface of each titanium oxide film, and an adhesive tape was adhered to the surface and the peeled off. Thereafter, the number of remaining squares was counted.

(3) Pencil hardness: According to JIS K5400 8.4.2 (1990), a pencil scratch test was carried out, and the titanium oxide films were checked for scratches to evaluate the pencil hardness.

(4) Oxygen permeability: A film oxygen permeability meter of Japan Industrial Products Research Institute type (manufactured by Rika Seiki Kogyo K.K.) was used to measure an oxygen permeability in water at 25° C. The unit of the permeability was [cm³(STP).cm/cm².s.cmHg].

Table 1 shows the materials of the plastic films and the test results.

TABLE 1

| | | Titanium | | | |
|---|---|---|---|---|---|
| | | oxide | | Pencil | |
| | Plastic | film | | hard- | Oxygen |
| | film | condition | Adhesion | ness | permeability |
| Ex. 1 | Oriented PP | Good | 100 | 3B | 7.20 × 10¹² |
| Ex. 2 | Oriented PP | Good | 100 | 3B | 7.60 × 10¹² |
| Ex. 3 | Oriented PP | Good | 100 | 3B | 7.40 × 10¹² |
| Ex. 4 | Oriented PP | Good | 100 | 3B | 7.60 × 10¹² |
| Ex. 5 | Oriented PP | Clouded | 100 | 3B | 1.02 × 10¹¹ |
| Ex. 6 | Oriented PP | Slightly | 100 | 3B | 7.60 × 10¹² |
| | | clouded | | | |
| Comp. | Oriented PP | Clouded | 0 | 4B or | 3.99 × 10¹¹ |
| Ex. 1 | | | | lower | |
| Comp. | Oriented PP | — | — | — | 7.21 × 10¹¹ |
| Ex. 2 | | | | | |
| Comp. | Copolymerized | — | — | — | 8.36 × 10¹² |
| Ex. 3 | PET | | | | |

In the table, PP means polypropylene, and
PET means polyethylene phthalate

Laminate Film Prepared using Titanium-Containing Aqueous Solution (a2) as Coating Material

### PRODUCTION EXAMPLE 8

A mixture of 10 parts of tetraisopropoxy titanium and 10 parts of isopropanol was added dropwise to a mixture of 5 parts (as solids) of “TKS-201” (a titanium oxide sol manufactured by TEICA Corp.), 10 parts of 30% aqueous hydrogen peroxide and 100 parts of deionized water, at 10° C. over 1 hour with stirring. The resulting mixture was aged at 10° C. for 24 hours, giving a yellow, transparent, slightly viscous aqueous peroxo titanic acid solution (a titanium-containing aqueous solution) having a solid content of 2%. This solution is used as titanium oxide film-forming coating material (8).

### PRODUCTION EXAMPLE 9

The procedure of Production Example 8 was repeated except that 10 parts of tetra-n-butoxy titanium was used in place of tetraisopropoxy titanium, giving a titanium-containing aqueous solution having a solid content of 2%. This solution was used as titanium oxide film-forming coating material (9).

### PRODUCTION EXAMPLE 10

The procedure of Production Example 8 was repeated except that 10 parts of trimer of tetraisopropoxy titanium was used in place of tetraisopropoxy titanium, giving a titanium-containing aqueous solution having a solid content of 2%. This solution was used as titanium oxide film-forming coating material (10).

### PRODUCTION EXAMPLE 11

The procedure of Production Example 8 was repeated except that a 3 times greater amount of aqueous hydrogen peroxide was used and the aging was carried out at 10° C. for 30 hours, giving a titanium-containing aqueous solution having a solid content of 2%. This solution was used as titanium oxide film-forming coating material (11).

### EXAMPLES 7 TO 10

Titanium oxide film-forming coating materials (8) to (11) were each applied to a dry thickness of 0.3 μm using a bar coater, to a corona discharge-treated surface of a biaxially oriented polypropylene film with a thickness of 20 μm. The coating materials were then dried at 120° C. for 5 minutes to form titanium oxide films. In this manner, laminate films of Examples 7 to 10 were obtained.

The films of Examples 7 to 10 were tested for titanium oxide film condition, adhesion, pencil hardness and oxygen permeability, by the methods described above.

Table 2 shows the material of the plastic films and the tests results. For comparison, the results of Comparative Example 2 was presented in Table 2.

TABLE 2

| | | Titanium | | | |
|---|---|---|---|---|---|
| | | oxide | | | |
| | Plastic | film | | Pencil | Oxygen |
| | film | condition | Adhesion | hardness | permeability |
| Ex. 7 | Oriented PP | Slightly | 100 | 3B | 1.00 × 10¹¹ |
| | | clouded | | | |
| Ex. 8 | Oriented PP | Slightly | 100 | 3B | 2.00 × 10¹¹ |
| | | clouded | | | |
| Ex. 9 | Oriented PP | Slightly | 100 | 3B | 1.50 × 10¹¹ |
| | | clouded | | | |
| Ex. 10 | Oriented PP | Slightly | 100 | 3B | 2.00 × 10¹¹ |
| | | clouded | | | |
| Comp. | Oriented PP | — | — | — | 7.21 × 10¹¹ |
| Ex. 1 | | | | | |

In the table, PP means polypropylene.

Laminate Films Prepared using Titanium Oxide Film-Forming Coating Materials Comprising Titanium-Containing Aqueous Liquid (a), Organic Basic Compound (b) and Aqueous Organic High Molecular Compound (c)

### PRODUCTION EXAMPLE 12

The titanium-containing aqueous solution obtained in Production Example 1 was heated at 95° C. for 6 hours to thereby obtain a whitish yellow, translucent dispersion of titanium oxide (titanium-containing aqueous solution) having a solid content of 2%.

### PRODUCTION EXAMPLE 13

A mixture of 10 parts of tetraisopropoxy titanium and 10 parts of isopropanol was added dropwise to a mixture of 5 parts (as solids) of “TKS-203” (a titanium oxide sol manufactured by TEICA Corp.), 10 parts of 30% aqueous hydrogen peroxide and 100 parts of deionized water, at 10° C. over 1 hour with stirring. The resulting mixture was aged at 10° C. for 24 hours, giving a yellow, transparent, slightly viscous aqueous peroxo titanic acid solution (titanium-containing aqueous solution) having a solid content of 2%.

### PRODUCTION EXAMPLE 14

1,200 parts of ethylene glycol monobutyl ether was placed in a reactor, heated and maintained at 100° C. Then, 400 parts of methacrylic acid, 500 parts of styrene, 100 parts of ethyl acrylate, 35 parts of “Perbutyl O” (a tradename of NIPPON OIL & FATS CO., LTD., a peroxide polymerization initiator) and 140 parts of ethylene glycol monobutyl ether were added dropwise over 3 hours. After completion of the addition, the resulting mixture was aged at 100° C. for 2 hours. Subsequently, 570 parts of n-butanol was added, giving a carboxyl-containing acrylic resin solution (AC-1) having a solid content of 36%. The obtained resin has a number average molecular weight of about 7,000 and an acid value of 260 mgKOH/g.

Subsequently, 800 parts of “Araldide AER6129 Resin” (a tradename of Asahi Kasei Epoxy Co., Ltd., an epoxy resin having an epoxy equivalent of 2,600) and 129 parts of diethylene glycol monobutyl ether were placed in another reactor, and heated with stirring to obtain a homogeneous solution. 556 parts of carboxyl-containing acrylic resin solution (AC-1) was added to the solution, followed by homogeneous mixing. Then, 66 parts of dimethylethanolamine was added. After maintaining the resulting mixture at 90° C. for 1 hour, 2,450 parts of water was added dropwise with stirring over 1 hour, giving a carboxyl-containing acrylic modified epoxy resin emulsion having an solid content of 25%.

### PRODUCTION EXAMPLE 15

1,880 g (0.5 mols) of “Epikote 1009 Resin” (a tradename of Shell Chemical Co., an epoxy resin having a molecular weight of 3,750) and 1,000 g of a solvent mixture (methyl isobutyl ketone/xylene=1/1 in weight ratio) were placed into a reactor equipped with a stirrer, a reflux condenser, a thermometer and a liquid dropper, and heated with stirring to obtain a homogeneous solution. Then, the solution was cooled to 70° C., and 70 g of di(n-propanol)amine weighed into the liquid dropper was added dropwise over 30 minutes. During the addition, the reaction temperature was maintained at 70° C. After completion of the addition, the reaction mixture was maintained at 120° C. for 2 hours to complete the reaction, giving an amine-modified epoxy resin having a solid content of 66%. 25 parts of 88% formic acid was added relative to 1,000 g of the resin. After addition of water, the mixture was fully mixed to thereby obtain an amine-modified epoxy resin emulsion having a solid content of 30%.

### PRODUCTION EXAMPLE 16

To 50 parts of “Hopesol A-5100X” (a tradename of Kyowa Hakko Kogyo Co., Ltd., an acrylic modified polyester resin solution having a solid content of 60%) were added 4 parts of “Mycoat 106” (a tradename of Mitsui-Cytec, Ltd., a benzoguanamine resin having a solid content of 77%) and 6 parts of “NACURE 5225” (a tradename of King Industries, Inc. (U.S.), an amine-neutralized solution of dodecyl benzenesulfonic acid having a dodecyl benzenesulfonic acid content of 25%). After addition of water, the resulting mixture was fully stirred, giving an acrylic-modified polyester/melamine-curable resin solution having a solid content of 30%.

### PRODUCTION EXAMPLE 17

As an aqueous urethane resin, “Adeka Bontighter HUX-401” (a tradename of Asahi Denka Kogyo K.K., an aqueous urethane resin dispersion having a solid content of 37%).

### PRODUCTION EXAMPLE 18 TO 26

Titanium oxide film-forming coating materials (12) to (20) were prepared from the components shown in Table 3, by adding and mixing an organic basic compound into a titanium-containing aqueous solution, and then adding and mixing an aqueous organic high molecular compound. Coating materials (12) to (19) are coating materials according to the invention, and the coating material (20) is a comparative coating material.

Table 3 shows the proportions of the components.

TABLE 3

| | | Titanium oxide film-forming coating material | | | | | | | | |
|---|---|---|---|---|---|---|---|---|---|---|
| | | (12) | (13) | (14) | (15) | (16) | (17) | (18) | (19) | (20) |
| Titanium- | Prod. | 100 | | | | | | | | |
| containing | Ex. 6 | | | | | | | | | |
| aqueous | Prod. | | 100 | 100 | 100 | 100 | 100 | | | |
| solution | Ex. 1 | | | | | | | | | |
| | Prod. | | | | | | | 100 | | |
| | Ex. 12 | | | | | | | | | |
| | prod. | | | | | | | | 100 | |
| | Ex. 13 | | | | | | | | | |
| | Prod. | | | | | | | | | 100 |
| | Ex. 7 | | | | | | | | | |
| Organic | 25% aq. | 0.02 | 0.2 | 0.2 | 0.2 | 0.2 | | 0.2 | 0.2 | |
| basic | ammonia | | | | | | | | | |
| compound | Dimethyl- | | | | | | 0.4 | | | |
| | ethanol- | | | | | | | | | |
| | amine | | | | | | | | | |
| Aqueous | Prod. | 1.5 | 1.0 | | | | 2.0 | | | 1.0 |
| organic | Ex. 14 | | | | | | | | | |
| high | Prod. | | | 1.5 | | | | | | |
| molecular | Ex. 15 | | | | | | | | | |
| compound | Prod. | | | | 1.0 | | | 1.0 | 2.0 | |
| | Ex. 16 | | | | | | | | | |
| | Prod. | | | | | 1.0 | | | | |
| | Ex. 17 | | | | | | | | | |

### EXAMPLES 11 TO 18 AND COMPARATIVE EXAMPLE 4

Each of titanium oxide film-forming coating materials (12) to (19) was applied to a dry thickness of 0.3 μm using a bar coater, to a corona discharge-treated surface of a biaxially oriented polypropylene film with a thickness of 20 μm. The coating materials were then dried at 120° C. for 5 minutes to form titanium oxide films. Thus, laminate films of Examples 11 to 18 were obtained. Further, a laminate film of Comparative Example 4 was prepared in the same manner as above, using titanium oxide film-forming coating material (20).

The films were tested for titanium oxide film condition, adhesion, pencil hardness and oxygen permeability by the methods described above. Also, the stability of the coating materials and the oxygen permeability of the films after rubbing were tested by the following methods.

(5) Stability of the coating materials: The coating materials were stored at 40° C. for 1 month to evaluate the stability by checking for abnormalities such as separation and gelation. Coating materials without abnormalities were rated good.

(6) Oxygen permeability after rubbing: Under a load of 500 g, each of the films (5 cm in width) was wound to a stainless steel tube of a 10 mm diameter in such a manner that the coated surface faced inside, and then unwound. This procedure was repeated 10 times. Thereafter, the films were tested for oxygen permeability by the method described above.

Table 4 shows the test results.

TABLE 4

| | | | | | | Oxygen |
|---|---|---|---|---|---|---|
| | Stability | | | | | permeability |
| | of coating | Titanium oxide | | Pencil | Oxygen | after |
| | material | film condition | Adhesion | hardness | permeability | rubbing |
| Ex. 11 | Good | Transparent | 100 | B | 7.51 × 10¹² | 7.62 × 10¹² |
| Ex. 12 | Good | Transparent | 100 | B | 7.20 × 10¹² | 7.44 × 10¹² |
| Ex. 13 | Good | Transparent | 100 | HB | 7.36 × 10¹² | 7.47 × 10¹² |
| Ex. 14 | Good | Transparent | 100 | HB | 7.29 × 10¹² | 7.41 × 10¹² |
| Ex. 15 | Good | Transparent | 100 | 3B | 7.22 × 10¹² | 7.28 × 10¹² |
| Ex. 16 | Good | Transparent | 100 | B | 7.88 × 10¹² | 7.93 × 10¹² |
| Ex. 17 | Good | Slightly | 100 | B | 7.65 × 10¹² | 7.71 × 10¹² |
| | | clouded | | | | |
| Ex. 18 | Good | Transparent | 100 | B | 8.80 × 10¹² | 8.86 × 10¹² |
| Comp. | Separated | Clouded | 86 | B | 3.87 × 10¹¹ | 6.08 × 10¹¹ |
| Ex. 4 | and | | | | | |
| | aggregated | | | | | |

In the present invention, a titanium oxide film layer is laminated at least one side of a plastic film. As a result, a gas barrier film is provided which has excellent barrier properties to gases such as oxygen, carbonic acid gas and water vapor, good UV screening properties, good flavor retention properties and high transparency.

In particular, when a titanium oxide film layer is laminated, on at least one side of a plastic film, using a titanium oxide film-forming coating material comprising a titanium-containing aqueous liquid (a), an organic basic compound (b) and an aqueous organic high molecular compound (c), the gas barrier film has improved processability and higher adhesion of the titanium oxide film layer to the plastic film.

Moreover, the gas barrier film of the invention can be produced at low cost, by a simple coating process that requires no specific techniques or equipment.

1-9. (canceled)

10. A gas barrier film comprising at least one titanium oxide film layer (B) laminated on one or both sides of a plastic film layer (A) the titanium oxide film layer (B) being laminated by:
applying, to the plastic film layer (A), a titanium oxide film-forming coating material comprising a titanium-containing aqueous liquid (a) obtained by mixing at least one titanium compound selected from the group consisting of hydrolyzable titanium compounds, low condensates of hydrolyzable titanium compounds, titanium hydroxide and low condensates of titanium hydroxide with aqueous hydrogen peroxide, an ammonia and/or organic basic compound (b) and an aqueous organic high molecular compound (c) stable at a pH not higher than 10; and
drying the coating material at a temperature not lower than 200° C., to produce said gas barrier film.

11. A film according to claim 10, wherein the titanium-containing aqueous liquid (a) is an aqueous peroxo titanic acid solution obtained by mixing a hydrolyzable titanium compound and/or its low condensate with aqueous hydrogen peroxide.

12. A film according to claim 11, wherein the hydrolyzable titanium compound is a tetraalkoxytitanium represented by the formula
Ti(OR)₄ (1)
wherein Rs are the same or different and each represent C₁ to C₅ alkyl.

13. A film according to claim 11, wherein the low condensate of a hydrolyzable titanium compound is a compound having a condensation degree of 2 to 30 and obtained by self-condensing a tetraalkoxytitanium represented by the formula
Ti(OR)₄ (1)
wherein Rs are the same or different and each represent C₁ to C₅ alkyl.

14. A film according to claim 11, wherein the proportion of the aqueous hydrogen peroxide is 0.1 to 100 parts by weight calculated as hydrogen peroxide, per 10 parts of the hydrolyzable titanium compound and/or its low condensate.

15. A film according to claim 11, wherein the titanium-containing aqueous liquid (a) is an aqueous peroxo titanic acid solution obtained by mixing a hydrolyzable titanium compound and/or its low condensate with aqueous hydrogen peroxide in the presence of a titanium oxide sol.

16. A film according to claim 15, wherein the titanium oxide sol is an aqueous dispersion of anatase titanium oxide.

17. A film according to claim 15, wherein the proportion of the titanium oxide sol is 0.01 to 10 parts by weight as solids, per 1 part by weight of the hydrolyzable titanium compound and/or its low condensate.

18. A film according to claim 10, wherein the ammonia and/or organic basic compound (b) has a boiling point not higher than 300° C.

19. A film according to claim 10, wherein the proportion of the ammonia and/or organic basic compound (b) is 0.001 to 10 parts by weight, per 100 parts by weight of the solids in the titanium-containing aqueous liquid (a).

20. A film according to claim 10, wherein the aqueous organic high molecular compound (c) is at least one resin selected from the group consisting of epoxy resins, phenol resins, acrylic resins, urethane resins, polyester resins, polyvinyl alcohol resins, polyoxyalkylene chain-containing resins and olefin-polymerizable unsaturated carboxylic acid copolymer resins.

21. A film according to claim 10, wherein the proportion of the aqueous organic high molecular compound (c) is 0.1 to 200 parts by weight per 100 parts by weight of the solids in the titanium-containing aqueous liquid (a).

22. A film according to claim 10, wherein the titanium oxide film-forming coating material is an aqueous coating material of pH 2 to 10.

23. A film according to claim 10, wherein part or all of the titanium oxide forming the layer (B) is amorphous titanium oxide.

24. A film according to claim 10, wherein the plastic film layer (A) is a food packaging plastic film layer.

25. A film according to claim 10 or 24, wherein the plastic film layer (A) is a polypropylene film layer.

26. A film according to claim 10, wherein the plastic film layer (A) is 5 to 100 μm thick.

27. A film according to claim 10, wherein the titanium oxide film layer (B) is 0.001 to 10 μm thick.
